(19) United States
(12) Patent Application Publication
(10) Pub. No.: US 2017/0099426 A1
(43) Pub. Date: Apr. 6, 2017

(54) LED SPEAKER IDENTIFIER SYSTEM

(71) Applicant: Polycom, Inc., San Jose, CA (US)

(72) Inventor: Alvin OKUNAMI, Round Rock, TX (US)

(21) Appl. No.: 14/873,026

(22) Filed: Oct. 1, 2015

(51) Int. Cl. H04N 5/232; H04N 7/15; F21V 23/00; F21V 33/00; F21V 7/00

(52) U.S. Cl. CPC H04N 5/23212; F21V 33/0052; F21V 7/0066; F21V 23/005; H04N 7/15; H04N 5/23238; F21W 2111/00

(57) ABSTRACT

A light-emitting diode (LED) speaker identification system that illuminates at least one LED in the direction in which a camera having a 360 degree field of view is recording. The LED speaker identification system includes a base, a printed circuit board coupled to a surface of the base, and a plurality of light-emitting diodes (LEDs) coupled to a surface of the printed circuit board around a circumference thereof. The plurality of LEDs are electrically connected to a camera having a 360 degree viewing angle.

### FIELD OF THE INVENTION

The invention relates to a system for indicating an identified speaker for use with a camera having a 360 degree viewing angle. The speaker identifier system activates light emitting diode(s) (LEDs) that indicate the direction in which the camera is pointing so that participants in a video conferencing session are aware of what is being captured by the camera.

### BACKGROUND OF THE INVENTION

Circular seating arrangements in conference rooms provide an advantage in allowing participants to interact and communicate more comfortably with everyone in the room. In fact, in a conference room where people meet in a circle, they are able to interact with each other better than in a traditional rectangular conference room. Each person can see other individuals in the room equally without having to turn their heads to see someone in the circle. To capture this interaction for video conferencing, a 360 degree camera may be placed in the middle of the group of participants. However, due to the design of the camera, the participants cannot easily discern the direction in which the camera is “pointing” so as to be able to know if they are being recorded.

Accordingly, an identification and indication system is needed that alerts participants to the focus of the camera.

### SUMMARY OF THE INVENTION

A speaker identification system is provided that may be used in connection with a 360 degree camera. More particularly, a system for indicating an identified speaker is described for use with a wide angle or 360 degree camera. The indication part of the system may be visual, touch or audio.

In some embodiments, the speaker identification system includes a plurality of light emitting diodes (LEDs) arranged in a circle that selectively activate in the direction that is being recorded by the camera. In this way, the LEDs “point” to the participant or participants that are being recorded at any given moment in time.

A lighted speaker identification system for use with a camera having a wide angle which includes a base having at least one surface, a printed circuit board coupled to the at least one surface of the base and operably connected to the camera having a wide angle view, and a plurality of lights operably connected to the printed circuit board and around an outer perimeter of the printed circuit board, wherein one or more of the plurality of lights are activated to indicate a camera angle.

A light-emitting diode speaker identification system is detailed, which includes a base having a plurality of separators situated around a circumference thereof and an opening extending through its center, a printed circuit board coupled to a surface of the base, such that an edge of the printed circuit board abuts the plurality of separators, the printed circuit board having an opening extending through its center, a plurality of light-emitting diodes (LEDs) coupled to a surface of the printed circuit board around a circumference thereof, such that each of the plurality of LEDs is spaced between each of the plurality of separators, at least one ribbon cable extending through the opening of the base and the opening of the printed circuit board which electrically connects to the printed circuit board, and at least one controller connected to the printed circuit board, wherein the printed circuit board is electrically connected to a camera having a 360 degree viewing angle by the at least one ribbon cable.

A method for visually indicating an active field of view of a 360 degree or wide angled camera is described. One method describes the steps of receiving from at least one microphone an audio signal, determining using a processor a first angular direction of the audio signal relative to the camera, directing, using electronics, the camera to capture an image in the first angular direction of the audio signal, and signaling a light assembly to activate at least one light on the light assembly, wherein the location of the at least one activated light corresponds to the first angular direction of the camera.

Lastly, a video conferencing system having a 360 degree camera is detailed. The conferencing system comprises a controller mounted on a circuit board, a multipath electrical connector to connect the circuit board with the 360 degree camera, a signal with data about an angular view of the 360 degree camera wherein the signal travels from the camera to the controller through the multipath electrical connector and is processed by the controller, and an indicator assembly operably connected to and controlled by the controller, wherein the indicator assembly is activated and indicates an angular view of the 360 degree camera.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is an exploded view of an LED assembly in accordance with one embodiment;

FIG. 2 is top perspective view of selected layers of the LED assembly illustrated in FIG. 1 in accordance with an embodiment;

FIG. 3 is a sectional top view of the layers of the LED assembly illustrated in FIG. 2 in accordance with an embodiment;

FIG. 4A is a side view of the LED assembly illustrated in FIG. 1 in accordance with an embodiment;

FIG. 4B is a bottom perspective view of the LED assembly illustrated in FIG. 4A;

FIG. 5 is a perspective view of a videoconference station utilizing the LED assembly illustrated in FIG. 1 in accordance with one embodiment;

FIG. 6 is a flow diagram illustrating a method of indicating an identified speaker in accordance with an embodiment;

FIG. 7 is a flow diagram illustrating a method of indicating an identified speaker in accordance with an embodiment; and

FIG. 8 is a diagram of an exemplary circuit board for use in an LED light indicator system.

### DETAILED DESCRIPTION

The speaker identification assembly described may be used in conjunction with a 360 degree camera or other wide angle camera. In a video conferencing setting, for example, where a camera having a 360 degree field of view is used, it is difficult for the participants of the video conference to ascertain where the camera is “focused” when it is recording. An indication system, such as a visual indication system, to inform the participants of the cameras direction or focus is desired.

In many embodiments, the speaker identification assembly communicates with or receives signals from the camera to determine the direction in which the camera is focused. Once this is established, the speaker identification assembly provides the participants with an indication relating to the direction of the camera's view. This informs the participants in a video conference room of which person, generally the speaker, is on camera.

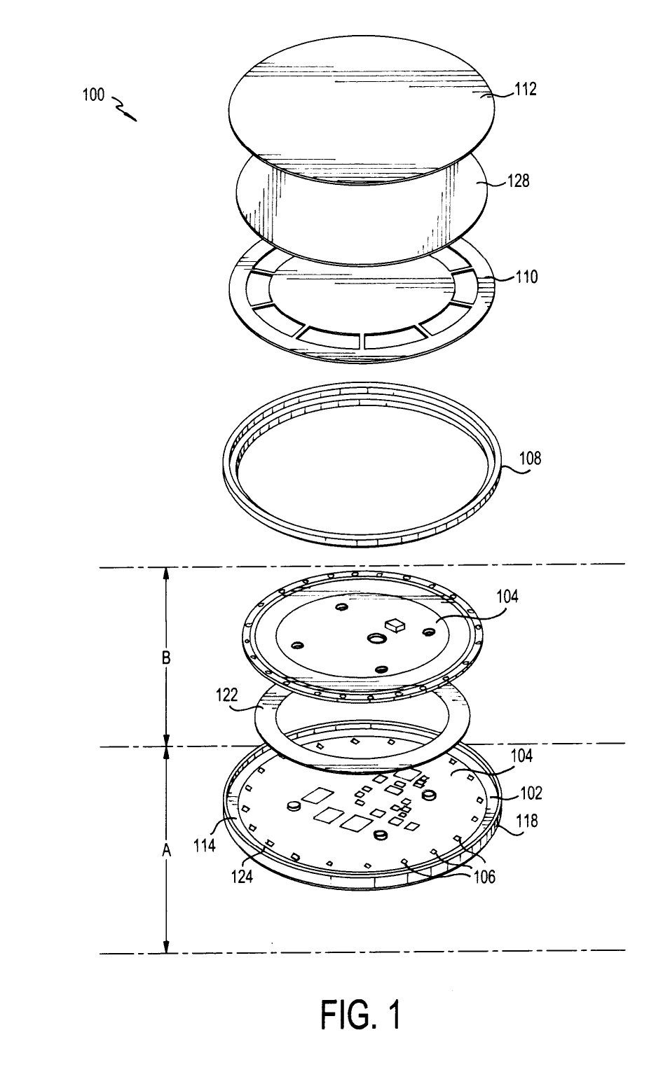

While various types of indicators may be used, a passive visual indicator is shown in FIGS. 1 through 4. One example of a passive visual indicator is a light assembly. A light assembly may have a series of lights to indicate the direction of a camera and identification of a speaker. More particularly, the visual indication system shown in FIGS. 1-4 activates one or more light-emitting diodes (LEDs) that correspond to the direction of the camera's focus. The activated LED or LEDs indicate the direction that the camera is pointing or recording. In this way, the participants in the video conference are notified as to where the camera is focused so that they may know that they (or someone else) is actively being recorded.

Referring to FIG. 1, the LED speaker identification assembly 100 (hereinafter referred to as “the LED assembly 100”) is a generally circular, stacked device used in conjunction with a camera having a 360 degree field of view. The LED assembly 100 is generally formed of a base 102, at least one printed circuit board 104, a plurality of LEDs 106, an optional diffuser 108, an optional reflector 110, and a cover 112. In one embodiment, the LED assembly 100 need not include the diffuser 108 or the reflector 110 if unnecessary for the particular application. As set forth below, the printed circuit board 104 is shown twice for illustrative purposes in FIG. 1. In one embodiment, when the entire LED assembly 100 is assembled, it has a height or thickness of about 0.1-2 inches (about 0.25-5.1 cm), preferably about 0.5 inches (about 1.27 cm). In other embodiments, the LED assembly 100 is smaller or larger. If the LED assembly 100 is too large, it will begin to block the view of the participants. If the LED assembly 100 is too small, participants may be unable to see the indicator lights. The size of the LED assembly 100 is based upon the application and user preference.

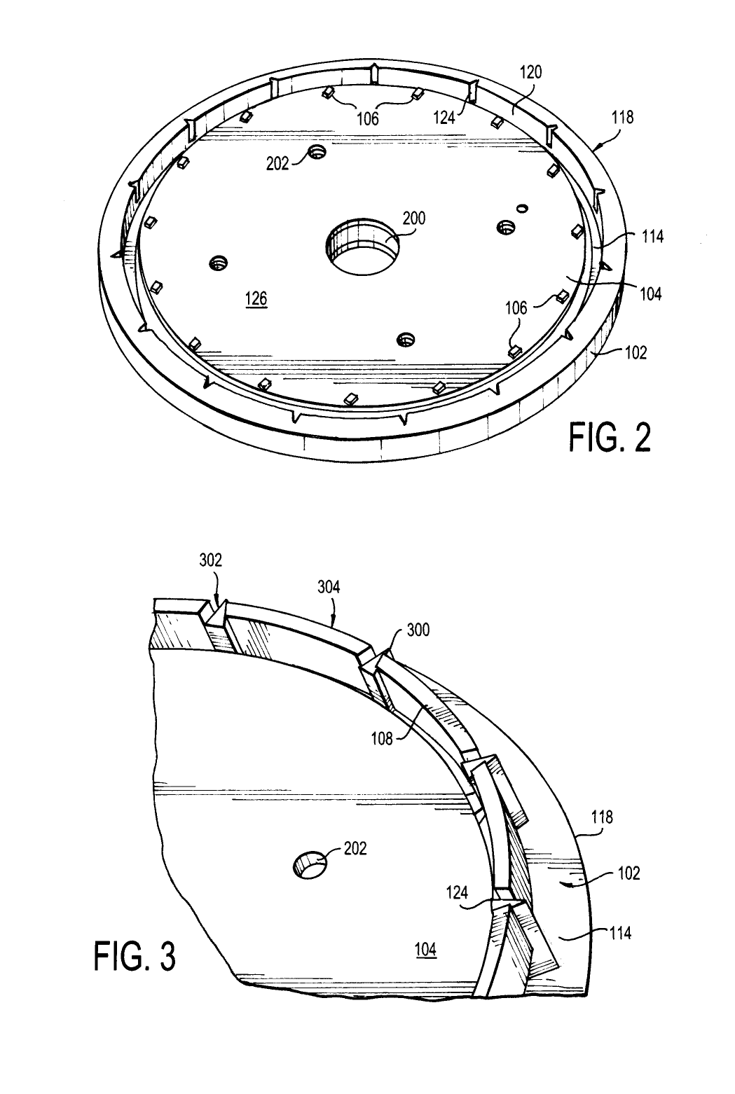

Referring to FIG. 2, the base 102 supports the LED assembly 100 as a whole. The base 102 is formed of a circular, flat substrate 114, such as a disk, having a substantially flat center portion which supports the LED assembly's 100 components. In one embodiment, an edge 118 of the base 102 may include a lip 120 that extends around the circumference of the base 102. The lip 120 physically protects the LED assembly's 100 components that are disposed on the center portion of the substrate 114. The base 102 may have a diameter of about 1-5 inches (about 2.5-12.7 cm), preferably about 3.5 inches (about 8.9 cm). The thickness of the base 102 may be about 0.1-1 inches (about 2.5-25.4 mm), preferably about 0.25 inches (about 6.5 mm) thick. The base 102 may be formed of any suitable material for a support for an LED assembly, such as metals, plastics, composites, and the like.

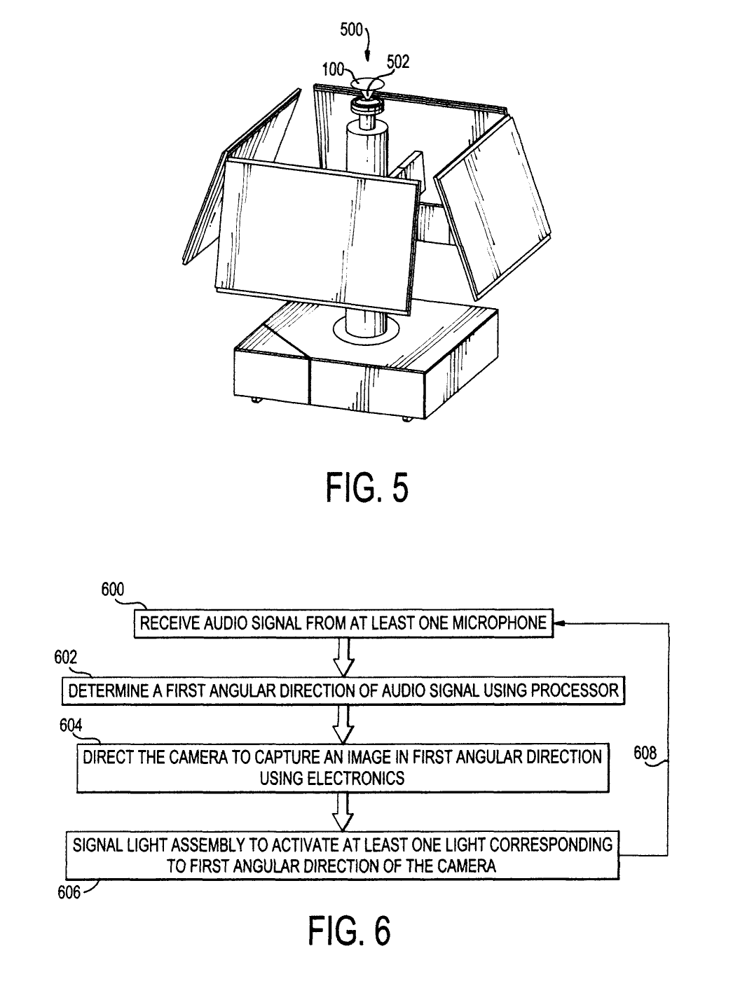

The at least one printed circuit board 104 (hereinafter referred to as “PCB 104”) generally has a circular, disk-like shape to correspond to the shape of the base 102. While not particularly limited, the PCB 104 may contain a microprocessor. In one embodiment, the PCB 104 includes an I2C computer bus for connections. The PCB 104 communicates with the camera 500 (see FIG. 5) to control activation of the plurality of LEDs 106. The PCB 104 is coupled to the center portion of the substrate 114 of the base 102 using any means known in the art. In one embodiment, the PCB 104 is coupled to the center portion 116 using double-sided tape 122, such as 3M™ VHB™ 5915 manufactured by The 3M Company of Maplewood, Minn. Section A of FIG. 1 shows the PCB 104 stacked on top of the double-sided tape 122 before it is coupled to the base 102. Section B of FIG. 1 shows the same PCB 104 after it has been coupled to the base 102. In one embodiment, the diameter of the PCB 104 is slightly smaller than the diameter of the base 102 so that an edge 124 of the PCB 104 is adjacent to, but not abutting, the edge 118 of the base 102. The diameter of the PCB 104 may be, for example, about 0.5-5 inches (about 1.27-12.7 cm), preferably about 3 inches (about 7.8 cm). Other suitable sizes and shapes may be used for the PCB 104.

As shown in FIG. 2, the LED assembly 100 further includes a plurality of LEDs 106 disposed on a surface 126 of the PCB 104. In one embodiment, the LEDs 106 are preferably spaced equally around a circumference of the PCB 104 and adjacent to the edge 124 of the PCB 104. In one embodiment, the LED assembly 100 includes twenty (20) individual LEDs 106 equally situated around the circumference of the PCB 104. In this embodiment, the LED assembly 100 includes twenty LEDs 106 because the camera 500 has a total of five imagers (not shown), and each imager is associated with four individual LEDs 106. However, more or less LEDs 106 may be incorporated into the LED assembly 100 depending on the number of imagers in the camera 500, which may be variable, or depending on other needs of a particular application. Generally, more lights provide a better indication of the angle the camera 500 is pointing to or focused upon. While there are no particular limits, typically the number of lights may range from 4 to as many as 360. The lights may also be arranged into various configurations, for example, to form an image of an arrow pointing at the identified speaker.

In one embodiment, the LEDs 106 are top-firing RGB LEDs, such as those manufactured by Kingbright of Taipei, Taiwan, e.g., Kingbright APTF1616SEEZGQBDC. Such LEDs are capable of showing different colors for different modes. The LEDs 106 typically run on about 20 mA of power. In other embodiments, simple single color LEDs are used. In still other embodiments, other types of visual indication devices are used, for example, light assemblies with various types of light sources. Some examples of light sources include, lights such as incandescent, neon, fluorescent, LCD, laser lights, etc.

In some visual indicator embodiments, a blinking light is used. The speed of the blinking light can be used to convey additional visual information to the participants, for example, the faster the blinking, the farther the focal point of the camera 500 and, conversely, the slower the blinking, the wider the angle of focus of the camera 500.

Further, alternative indication devices may be used in the speaker identification system. An addressable lighting display may be used. A round LCD display may be used. In embodiments in which there are video display screens, such as those shown in FIG. 5, an indication may be shown on the video display screen. The visual indication may be located on that portion of the screen closest to the camera angle being streamed or recorded. A picture-on-picture or overlay may be used as the visual indicator. An icon may be used and placed on the display, for example, a line drawing of a camera shown in red, a smiley face, an orange director's cone, etc. Animation may also be used to show that the camera 500 is videotaping, for example, a revolving film reel on a camera. In some embodiments, two indicators are used simultaneously. For example, a light indicator as well as an indicator on a screen.

In other embodiments, the indicators are non-visual and may be touch or sound. In embodiments in which the participants have electronic devices registered with the video conferencing system, the registered participant's device may be sent as an electronic indication. The registered device will then inform the participant that he or she is on camera. Typically, this will be accomplished by vibrating the participant's smart phone or vibrating the participant's watch. This has the side benefit of ensuring the participant is not unaware or asleep while the camera is focused on the person. This feature is particularly helpful if the participant has his or her back to the visual indication system. The registered device could also receive an electronic-type message by email, Twitter®, Lync®, flash message or the like. The registered device screen may flash the indication of the camera location.

Referring to the light indication embodiments of FIGS. 1-4, as illustrated in FIGS. 2-3, both the base 102 and the PCB 104 have at least one opening 200 extending all the way through a center of each component. This opening 200 allows at least one ribbon cable (not shown) to extend from the PCB 104 through the base 102 and into the camera 500 to connect to the camera's circuit board (discussed below). In this way, the PCB 104 and camera circuit board (not shown) are electrically connected and may communicate with each other to control the activation of the LEDs 106. The at least one ribbon cable (not shown) also supplies power to the LEDs 106. In an embodiment where double-sided tape 122 is not used to secure the PCB 104 to the base 102, the base 102 and the PCB 104 may further include a plurality of holes 202 for screwing the PCB 104 to the base 102.

As illustrated in FIG. 3, the base 102 further includes a plurality of separators 300 situated around the circumference of the base 102 near the edge 118 of the base 102. The separators 300 provide a physical barrier so as to prevent the light emanating from one LED to interfere with the light emanating from an adjacent LED. The separators 300 have a generally triangular shape, although any shape known in the art may be utilized, and project upward from the substrate 114 of the base 102. Each of the separators 300 has a height at least equal to the height of each individual LED 106. In one embodiment, the base 102 includes twenty (20) separators 300, although any number of separators may be used depending on the needs of the particular application. Each of the individual LEDs 106 is positioned between each of the individual separators 300 on the base 102. In this way, the light emanating from each individual LED 106 is physically blocked from interfering with the light emanating from an adjacent LED 106. For example, if adjacent LEDs are illuminated with different colors, the separators 300 will block that light from each LED so that they do not interfere with one another and create yet a different color that may confuse participants.

Referring back to FIG. 1, the LED assembly 100 may further include additional layers that are positioned together in a stacked arrangement with the base 102 and the PCB 104. The top layer of the LED assembly is a cover 112. The cover 112 encloses the PCB 104 and LEDs 106, such that the PCB 104 and LEDs 106 are sandwiched together between the base 102 and the cover 112. This arrangement protects the PCB 104 and LEDs 106 from wear and tear when the LED assembly 100 is in use or being moved.

The LED assembly 100 may also include additional layers that adjust the properties of the emanated LED light, such as diffuser 108 and/or a reflector 110. The diffuser 108 functions to adjust various properties of the emanated LED light, including equalizing the brightness across each LED light to minimize hot spots (bright areas). The diffuser 108 is a ring-shaped member that is placed around the edge 124 of the PCB 104 on the substrate 114 of the base 102. In one embodiment, the diffuser 108 may be coupled to the substrate 114 using screws, bolts, double-sided tape, glue, or the like. As illustrated in FIG. 3, the diffuser 108 may include openings 302 along its perimeter 304 through which each of the plurality of separators 300 may extend. In this way, the diffuser 108 abuts the edge 124 of the PCB 104 without interfering with the separators 300. The material used to form the diffuser 108 is not limited and is known to one skilled in the art.

The reflector 110 sits just beneath the cover 112 and may be coupled to the cover 112 using double-sided tape 128, which may be the same as the double-sided tape 122 used to couple the PCB 104 to the base 102. The reflector 110 is a circular, disk-like structure that has a shape diameter similar to that of the PCB 104 so as to extend to the edge 124 of the PCB 104 over the plurality of LEDs 106. The reflector 110 reflects the emanated LED light and projects it upwards through the cover 112. In this way, the LED light may emanate from the top and the side of the LED assembly 100. The design of the reflector 110 and material used to form the reflector 110 are not particularly limited and are known in the art.

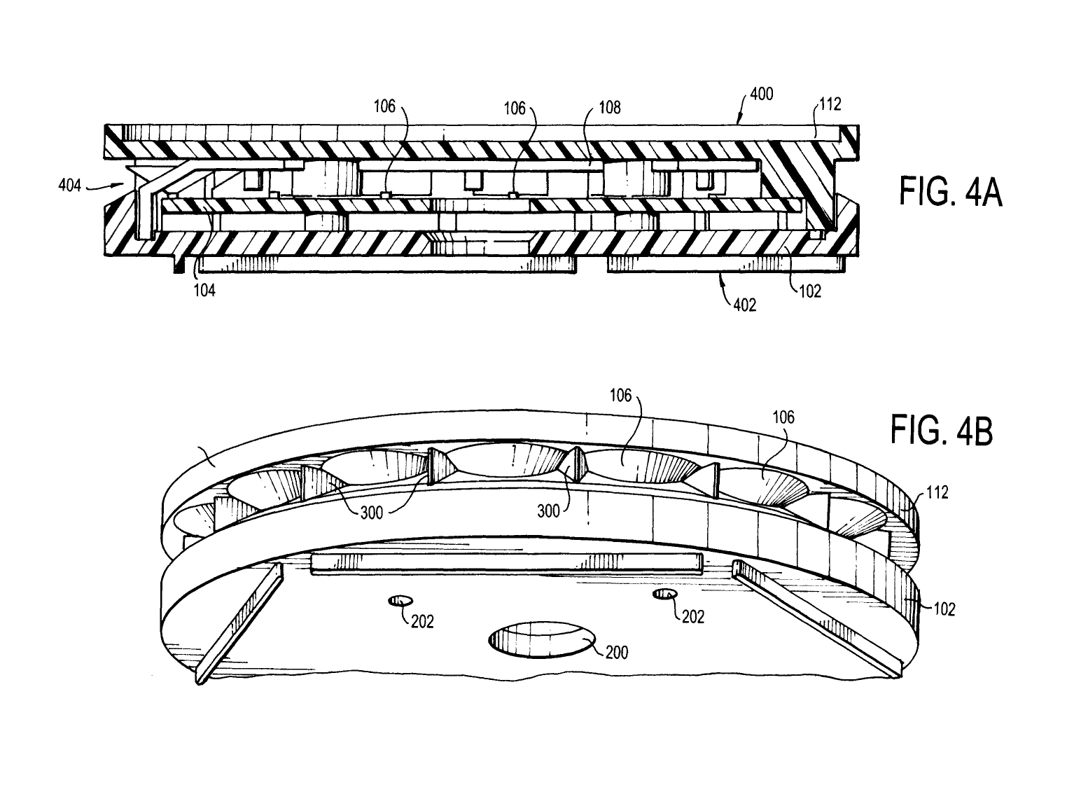

Side views of the fully assembled LED assembly 100 are illustrated in FIGS. 4A-B. This particular embodiment does not include a reflector 110. The cover 112 and the base 102 form the top 400 and bottom 402 of the LED assembly 100, respectively. The PCB 104 is coupled to the base 102, and the plurality of LEDs 106 are disposed on a surface of the PCB 104. Each individual LED 106 is positioned between each individual separator 300 such that the light from neighboring LEDs 106, which may have varying color as shown in FIG. 4B, does not interfere with each other. A diffuser 108 is positioned around the edge 124 of the PCB 104 so as to adjust the emanated LED light. In one embodiment, the LED light may emanate from a side 404 of the LED assembly 100, the top 400, and/or the bottom 402 of the LED assembly 100.

As illustrated in FIG. 5, when in use, the LED assembly 100 is coupled and electrically connected to a camera 500. The camera 500 is a panoramic camera which includes multiple cameras oriented so that individual images captured by the cameras can be combined to form a panoramic image. In one embodiment, the camera 500 has five (5) imagers that face upward and receive images reflected off of the pentagonal mirror 502. As such, the camera 500 has a 360 degree viewing field, with each imager capturing a view of 72 degrees. An example of a suitable camera is disclosed in U.S. patent application Ser. No. 11/027,068, published as U.S. Patent Application Publication No. 2005/0117015, and incorporated herein by reference. The base 102 of the LED assembly 100 is coupled to a top surface of the pentagonal mirror 502 on the camera 500 using, for example, double-sided tape such as that disclosed herein. In an alternative embodiment, the cover 112 of the LED assembly 100 may be coupled to a bottom surface of the camera 500. The camera 500 shown has a 360 degree viewing field.

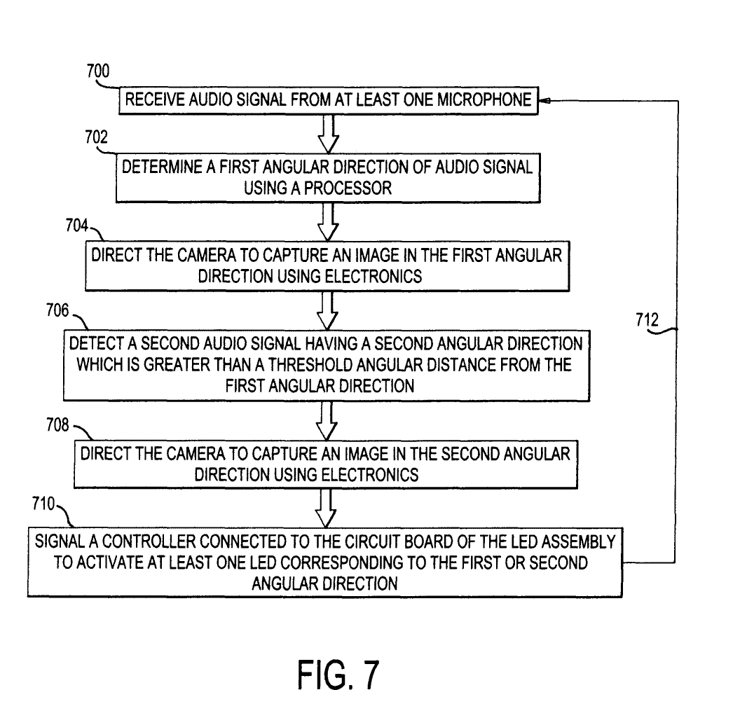

Flow diagrams setting forth methods of indicating an active field of view of a camera 500 are provided in FIGS. 6-7. The camera 500 works in conjunction with at least one microphone that receives audio signals from participants in the video conference, as set forth in Steps 600, 700. The camera utilizes Sound Source Localization (SSL) software and associated processors to determine (through a geometric calculation) the angular direction of the sound captured by the microphone(s) within the 360 degree view of the camera 500, as illustrated in Steps 602, 702. The SSL software then sends a “pointer” associated with a 0-359 vector value to a controller (not shown) that directs the camera 500 to focus on the “active speaker” within the panoramic view, as set forth in Steps 604, 704. In this way, the camera 500 captures an image associated with the angular direction of the audio signal, 604, 704. Any such SSL software that is known in the art may be used in connection with the camera 500. While not utilizing a camera having a 360 degree field of view, the sound tracking methods of U.S. Patent Application Publication Nos. 2011/0285807 and 2013/0271559, and U.S. Pat. No. 5,778,082, which are incorporated herein by reference, may be utilized with such a 360 degree camera.

As set forth above, the software directs the camera 500 to “point” to the location from which the sound emanates. Depending on the particular vector value, i.e., the location of the active speaker, a processor sends a signal to a light assembly, 606, 710. In some embodiments, a circuit board (not shown) on the camera 500 signals the LED assembly 100 to activate one or more of the LEDs 106 corresponding to the angular vector value, as illustrated in Steps 606, 710. For example, if a participant is seated at 90 degrees, the software processes the sound and directs the camera 500 to “point” to the vector value associated with 90 degrees, 602, 604, 702, 704. In turn, the LED assembly 100 activates one of the LEDs 106 that is most closely aligned with the 90 degree vector value. Alternatively, the LED assembly 100 may activate a series of LEDs 106 surrounding the 90 degree position to indicate that the camera 500 is recording within that field of view. For example, if the camera 500 is capturing anything within the 75-105 degree field, the LED 106 at the 90 degree position may light in one color or may have the brightest light intensity, while the LEDs 106 aligned with the surrounding positions, i.e., 75-90 degrees and 90-105 degrees, may light in another color or have a dimmer light intensity. In one embodiment, the LED 106 associated with the exact position of the camera 500 may light red, while the surrounding LEDs 106 associated with the surrounding field of the view of the camera 500 may light yellow. As set forth herein, in a preferred embodiment, the LEI) assembly 100 includes twenty LEDs 106, such that each LED is associated with an 18 degree field of illumination. Other arrangements of light assemblies and lights may be used, for example, one light for every 12 degrees of view.

The entire process set forth above is then repeated when a second audio signal is received by the microphone(s) in a different angular location. Specifically, where the microphone detects another audio signal that has an angular direction which is greater than a threshold angular distance measured from the angular direction of the first audio signal detected, such as at least 18 degrees different, as set forth in Step 706, the camera 500 is then directed by the controller to capture an image in the second angular direction field of view, as set forth in Step 708. This process is repeated as different audio signals are detected within the 360 degree view of view of the camera 500, as shown in Steps 608, 712. However, in order to filter “background noise” from what is actually intended to be captured by the camera 500, the SSL and associated processor(s) wait for a certain period of time (for example, at least 2-5 seconds) before directing the controller to adjust the field of view of the camera 500, in order to see if the source of the second audio signal emanating from a different angular location than the first audio signal is nothing more than an unintentional background noise, such as a cough from one of the participants. In practice, the audio analysis or SSL will continually sample and determine in which direction to “point” or focus the camera 500.

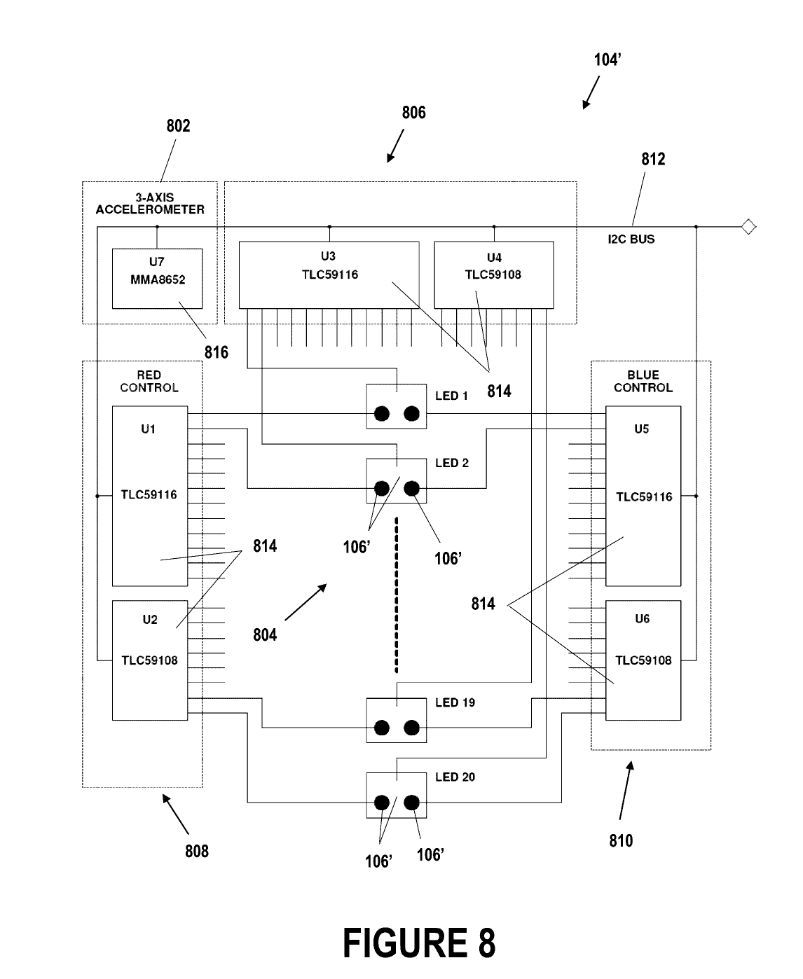

FIG. 8 is a diagram of an exemplary PCB 104′ for use in an LED light indicator system. Referring to FIG. 8, the exemplary PCB 104′ is shown generally having five sections: (i) a 3-axis accelerometer 802, (ii) an LED light section 804, (iii) a green control section 806, (iv) a red control section 808, and (v) a blue control section 810. All of these sections, except the LED light section 804, are connected to an I2C bus 812. The PCB 104′ includes the I2C bus 812 to communicate with another circuit board connected to a camera, such as camera 500. In this example, twenty (20) LED lights 106′ are shown in the LED light section 804. The LEDs 106′ shown are each RGBs. The LEDs 106′ are each connected to the three color controls, 806, 808, and 810.

Each of the color control sections, namely, green control section 806, red control section 808, and blue control section 810, comprises at least two controllers 814 for controlling the color functions of the LEDs. These controllers 814 communicate with each other and are operably connected to one or more colored LEDs 106′ for changing the color of the LED 106′. Specifically, each control section 806, 808, 810 is utilized for activating its designating color. As set forth above, each control section 806, 808, 810 is in communication with the I2C bus 812. In one embodiment, an exemplary LED assembly 100 may include at least one Texas Instruments TLC59108 controller and at least one Texas Instruments TLC59116 controller, both manufactured by Texas Instruments Inc. of Dallas, Tex.

The 3-axis accelerometer 802 includes its own accelerometer controller, 816. When the camera 500 is in use, it should be level with the faces of the participants in the room (or as close as possible to level) for optimal use in a video conference setting. The accelerometer 802 can be used to determine if the camera 500 is not horizontal. If the camera 500 is not horizontal, adjustments can be made to level the camera 500. If the camera 500 is too low or too high, it will not capture the faces of the participants, such that other participants in another location will not be able to tell who is speaking. Adjustments can be made to resolve the height problem. Any suitable accelerometer may be used, such as a Freescale Semiconductor MMA8652 accelerometer manufactured by Freescale Semiconductor, Inc. of Austin, Tex.

In other alternative embodiments, other types and amounts of controllers may be used, and other exemplary PCBs may utilize different configurations according to the particular needs of the application.

As set forth above, a PCB 104, 104′ is electrically connected to the camera 500, more specifically, to a printed circuit board (not shown) within the camera 500. In this way, the camera 500 communicates with the PCB 104, 104′ in order for the PCB 104, 104′ to determine the field of view of the camera 500. In one embodiment, each LEI) 106′ is controlled by at least one controller positioned on the PCB 104′ (as shown in the diagram of FIG. 8). The controllers 814 control the functions of each LED 106′, including which color is to be displayed. In operation, the SSL software processes the directional source of a sound and activates the camera 500 to record in that direction. The printed circuit board in the camera 500 in turn communicates the directional value of the camera 500 to the PCB 104, 104′ for the LED assembly 100. The PCB 104, 104′ then communicates with the controllers 814 which activate each of the individual LEDs 106, 106′.

Although the LED assembly 100 has been described in connection with specific forms and embodiments thereof, it will be appreciated that various modifications other than those discussed above may be resorted to without departing from the spirit or scope. For example, equivalent elements may be substituted for those specifically shown and described, certain features may be used independently of other features, and in certain cases, particular locations of elements may be reversed or interposed, all without departing from the spirit or scope as defined in the appended Claims.

What is claimed is:

1. A lighted speaker identification system for use with a camera having a wide angle, comprising:
a base having at least one surface;
a printed circuit board coupled to the at least one surface of the base and operably connected to the camera having a wide angle view; and
a plurality of lights operably connected to the printed circuit board and around an outer perimeter of the printed circuit board,
wherein one or more of the plurality of lights are activated to indicate a camera angle.

2. The lighted speaker identification system of claim 1, wherein the base is disk shaped, further comprising a plurality of separators situated around a circumference thereof and spaced between each of the plurality of lights.

3. The lighted speaker identification system of claim 1, wherein the printed circuit board is coupled to the base via double-sided tape.

4. The lighted speaker identification system of claim 1, wherein the base and the printed circuit board each have an opening extending through a center thereof.

5. The lighted speaker identification system of claim 4, further comprising at least one ribbon cable extending through the opening of the base and the opening of the printed circuit board and electrically connecting to the printed circuit board.

6. The lighted speaker identification system of claim 5, wherein the at least one ribbon cable electrically connects the printed circuit board to the camera.

7. The lighted speaker identification system of claim 1, wherein the plurality of lights are light-emitting diodes (LEDs) coupled to the surface of the printed circuit board.

8. The lighted speaker identification system of claim 7, wherein the LEDs are top-firing RGB LEDs.

9. The lighted speaker identification system of claim 1, wherein the plurality of lights comprises twenty (20) lights.

10. The lighted speaker identification system of claim 9, wherein the printed circuit board is disk shaped, the twenty lights are positioned around the circumference of the printed circuit board and each of the twenty lights has an 18 degree field of illumination.

11. The lighted speaker identification system of claim 1, further comprising a top cover which encloses the printed circuit board and the plurality of lights between the top cover and the base.

12. The lighted speaker identification system of claim 1, further comprising a reflector stacked on top of the printed circuit board and covering the plurality of lights.

13. The lighted speaker identification system of claim 12, further comprising a diffuser ring situated around an outer edge printed circuit board.

14. The lighted speaker identification system of claim 1, further comprising at least one controller electrically connected to the printed circuit board to control activation of each of the lights.

15. The lighted speaker identification system of claim 14, wherein the printed circuit board communicates between the camera and the at least one controller to activate at least one of the lights which is in closest proximity to a field of view of the camera while recording.

16. The lighted speaker identification system of claim 1, wherein the total thickness of the light-emitting diode speaker identification system is about 0.5 inches.

17. The lighted speaker identification system of claim 1, wherein the lighted speaker identification system is removably coupled to a top of the camera.

18. The lighted speaker identification system of claim 1, further comprising an accelerometer coupled to the printed circuit board to ensure that the camera is level.

19. The lighted speaker identification system of claim 1, wherein three or more of the plurality of lights are activated to indicate a camera angle.

20. The lighted speaker identification system of claim 19, wherein one of the three of more lights is a different color than remaining three or more lights.

21. A light-emitting diode speaker identification system, comprising:
a base having a plurality of separators situated around a circumference thereof and an opening extending through its center;
a printed circuit board coupled to a surface of the base, such that an edge of the printed circuit board abuts the plurality of separators, the printed circuit board having an opening extending through its center;
a plurality of light-emitting diodes (LEDs) coupled to a surface of the printed circuit board around a circumference thereof, such that each of the plurality of LEDs is spaced between each of the plurality of separators;
at least one ribbon cable extending through the opening of the base and the opening of the printed circuit board which electrically connects to the printed circuit board; and
at least one controller connected to the printed circuit board,
wherein the printed circuit board is electrically connected to a camera having a 360 degree viewing angle by the at least one ribbon cable.

22. A method for visually indicating an active field of view of a 360 degree or wide angled camera comprising the steps of:
a. receiving from at least one microphone an audio signal;
b. determining using a processor a first angular direction of the audio signal relative to the camera;
c. directing, using electronics, the camera to capture an image in the first angular direction of the audio signal; and
d. signaling a light assembly to activate at least one light on the light assembly, wherein the location of the at least one activated light corresponds to the first angular direction of the camera.

23. The method of claim 20, further comprising activating light emitting diodes, wherein the light assembly is a light-emitting diode (LED) speaker indication system comprising:
a base having at least one surface;
a printed circuit board coupled to the at least one surface of the base; and
a plurality of light-emitting diodes (LEDs) coupled to a surface of the printed circuit board around a circumference thereof,
wherein the plurality of LEDs are electrically connected to the camera.

24. The method of claim 20, wherein the signaling is performed by a circuit board on a camera and further comprises sending a signal to an LED assembly.

25. The method of claim 20, further comprising controlling a plurality of light emitting diodes using a printed circuit board and the signaling.

26. The method of claim 20, further comprising the step of detecting a second audio signal having a second angular direction which is greater than a threshold angular distance from the first angular direction.

27. The method of claim 20 further comprising the step of activating an indicator wherein the indicator informs of the first angular direction of the camera.

28. A video conferencing system having a 360 degree camera comprising:
a controller mounted on a circuit board;
a multipath electrical connector to connect the circuit board with the 360 degree camera;
a signal with data about an angular view of the 360 degree camera wherein the signal travels from the camera to the controller through the multipath electrical connector and is processed by the controller; and
an indicator assembly operably connected to and controlled by the controller, wherein the indicator assembly is activated and indicates an angular view of the 360 degree camera.
